(19) United States
(12) Patent Application Publication
(10) Pub. No.: US 2024/0124147 A1
(43) Pub. Date: Apr. 18, 2024

(54) GAS TURBINE ENGINE MOUNT

(71) Applicant: General Electric Company, Schenectady, NY (US)

(72) Inventors: William Joseph Bowden, Cleves, OH (US); Jonathan Edward Coleman, Mason, OH (US); Sharad Tiwari, Istanbul (TR); Srinivas Addagatla, Gebze (TR); Sara Elizabeth Carle, Hilliard, OH (US)

(21) Appl. No.: 17/964,982

(22) Filed: Oct. 13, 2022

(51) Int. Cl. B64D 27/12; B64D 27/26; F02C 7/20

(52) U.S. Cl. CPC B64D 27/12; B64D 27/26; F02C 7/20; F05D 2220/323; F05D 2240/90

(57) ABSTRACT

A gas turbine engine includes an aft frame and a forward frame disposed upstream from the aft frame. The forward frame includes an outer ring. The outer ring includes an inner surface that is radially spaced from an outer surface. A first indention is defined in the outer surface, and a first engine mount flange protrudes radially outwardly from the first indention.

### FIELD

The present disclosure relates to gas turbine engine mounts.

### BACKGROUND

Aircraft may be powered by one or more gas turbine engines. The engine(s) may be mounted to the aircraft via one or more engine frames configured to interlock or couple to a pylon or other mounting feature of the aircraft structure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is perspective view of an exemplary aircraft in accordance with an exemplary embodiment of the present disclosure.

FIG. 2 is a schematic cross-sectional view of a three-stream engine in accordance with an exemplary embodiment of the present disclosure.

FIG. 3 is a schematic cross-sectional view of a portion of the gas turbine engine as shown in FIG. 2 according to exemplary embodiments of the present disclosure.

FIG. 4 is a front perspective view of an exemplary forward frame according to exemplary embodiments of the present disclosure.

FIG. 5 is a back perspective view of the exemplary forward frame as shown in FIG. 4, according to various embodiments of the present disclosure.

FIG. 6 is a top partial view of the exemplary forward frame as shown in FIGS. 4 and 5, according to various embodiments of the present disclosure.

FIG. 7 is a rear side perspective view of an exemplary forward frame according to particular embodiments of the present disclosure.

FIG. 8 is a front partial view of the exemplary forward frame as shown in FIG. 7 according to particular embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or aircraft and refer to the normal operational attitude of the gas turbine engine or aircraft. For example, with regards to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

Generally, exhaust flowing from an open fan prop or unducted primary fan of a turbofan engine is sonic or even supersonic at climb and cruise conditions. This high-speed exhaust flow scrubs across or by the nacelle and pylon fairing. For sonic and supersonic flow around the nacelle and pylon fairing, shocks and shock losses are expected and can result in a considerable penalty to aircraft-level performance such as fuel burn rate and drag. Engine mounts are a key constraint on the nacelle flow path and depressing the engine mounts into an engine's frame, particularly the forward frame, enables a smoother, lower profile, more continuous curvature flow path around the engine nacelle and any local fairings around the engine mounts. The design disclosed herein reduces total drag, peak Mach numbers occurring on the nacelle and/or pylon, and therefore the risk of wave drag.

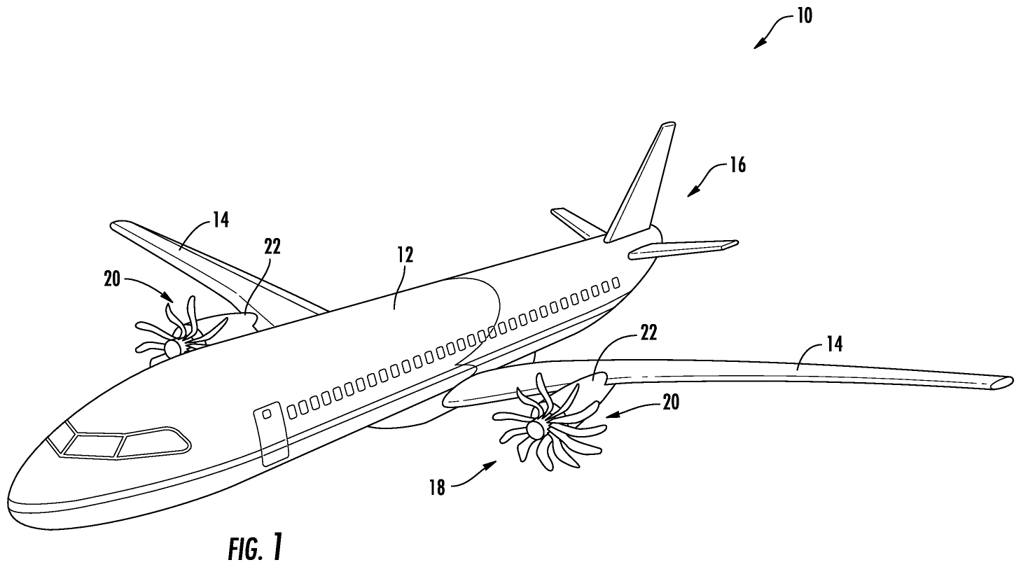

Referring now to the drawings, FIG. 1 is a perspective view of an exemplary aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing(s) 14, in other embodiments it may additionally or alternatively include one or more aspects coupled to other parts of the aircraft 10, such as, for example, the empennage 16, the fuselage 12, etc. The propulsion system 18 includes at least one engine. In the exemplary embodiment shown, the aircraft 10 includes a pair of gas turbine engines 20. In particular embodiments, each gas turbine engine 20 is mounted to the aircraft 10 in an under-wing configuration via a respective pylon 22. Each gas turbine engine 20 is capable of selectively generating a propulsive thrust for the aircraft 10. It is to be appreciated that the gas turbine engines 20 may also be mounted in other locations of the aircraft such as but not limited to the empennage 16. In addition, the gas turbine engines 20 may be configured to burn various forms of fuel including, but not limited to unless otherwise provided, jet fuel/aviation turbine fuel, and hydrogen fuel.

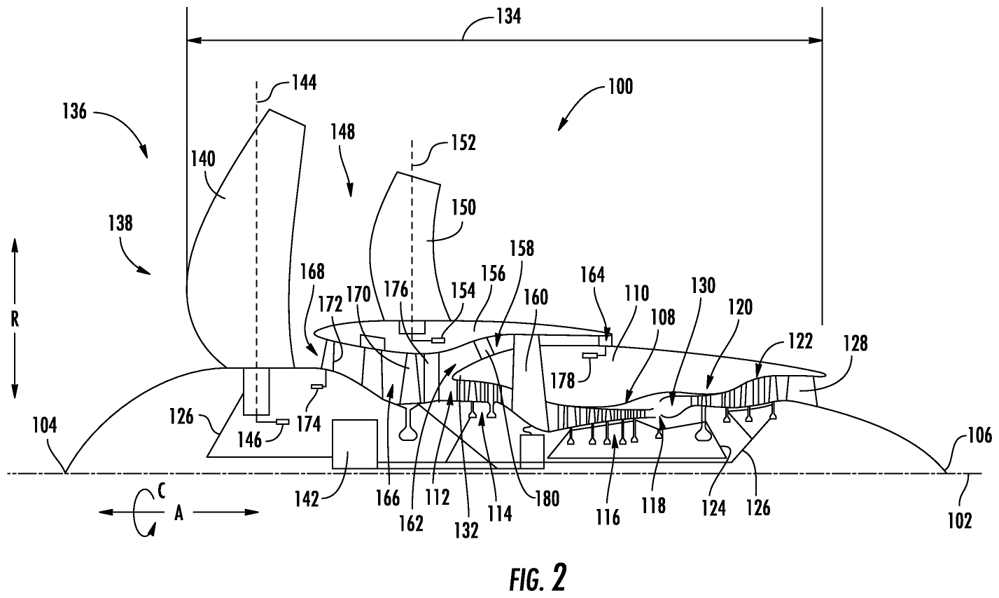

FIG. 2 is a schematic cross-sectional view of a gas turbine engine 100 according to another example embodiment of the present disclosure. Particularly, FIG. 2 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 2 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 102 that extends along the axial direction A. In general, the axial direction A extends parallel to the longitudinal axis 102, the radial direction R extends outward from and inward to the longitudinal axis 102 in a direction orthogonal to the axial direction A, and the circumferential direction extends three hundred sixty degrees (360°) around the longitudinal axis 102. The engine 100 extends between a forward end 104 and an aft end 106, e.g., along the axial direction A.

As shown in FIG. 2 the engine 100 includes a turbomachine 108 having a fan section 136 that is positioned upstream thereof. Generally, the turbomachine 108 includes, in serial flow order, a compressor section, a combustion section, a turbine section, and an exhaust section. Particularly, as shown in FIG. 2, the turbomachine 108 includes a core cowl 110 that defines an annular core inlet 112. The core cowl 110 further encloses at least in part a low-pressure system and a high-pressure system. For example, the core cowl 110 depicted encloses and supports at least in part a booster or low-pressure compressor 114 for pressurizing the air that enters the turbomachine 108 through core inlet 112. A high-pressure, multi-stage, axial-flow compressor 116 receives pressurized air from the low-pressure compressor 114 and further increases the pressure of the air. The pressurized air stream flows downstream to a combustor 118 of the combustion section where fuel is injected into the pressurized air stream and ignited to raise the temperature and energy level of the pressurized air.

It will be appreciated that as used herein, the terms “high/low speed” and “high/low-pressure” are used with respect to the high-pressure/high speed system and low-pressure/low speed system interchangeably. Further, it will be appreciated that the terms “high” and “low” are used in this same context to distinguish the two systems and are not meant to imply any absolute speed and/or pressure values.

The high energy combustion products flow from the combustor 118 downstream to a high-pressure turbine 120. The high-pressure turbine 120 drives the high-pressure compressor 116 through a high-pressure shaft 124. In this regard, the high-pressure turbine 120 is drivingly coupled with the high-pressure compressor 116. The high energy combustion products then flow to a low-pressure turbine 122. The low-pressure turbine 122 drives the low-pressure compressor 114 and components of the fan section 136 through a low-pressure shaft 126. In this regard, the low-pressure turbine 122 is drivingly coupled with the low-pressure compressor 114 and components of the fan section 136. The low-pressure shaft 126 is coaxial with the high-pressure shaft 124 in this example embodiment. After driving each of the high-pressure turbine 120 and the low-pressure turbine 122, the combustion products exit the turbomachine 108 through a turbomachine exhaust nozzle 128. A core engine 134 of the gas turbine engine 100 is defined as the part of the gas turbine engine 100 that extends from the fan blades 140 of the fan section 136 to the turbomachine exhaust nozzle 128.

Accordingly, the turbomachine 108 defines a working gas flowpath or core duct 130 that extends between the core inlet 112 and the turbomachine exhaust nozzle 128. The core duct 130 is an annular duct positioned generally inward of the core cowl 110 along the radial direction R. The core duct 130 (e.g., the working gas flowpath through the turbomachine 108) may be referred to as a second stream. The fan section 136 includes a fan 138, which is the primary fan in this example embodiment. For the depicted embodiment of FIG. 2, the fan 138 is an open rotor or unducted fan 138. In such a manner, the engine 100 may be referred to as an open rotor engine.

As depicted, the fan 138 includes a plurality or an array of fan blades 140 (only one shown in FIG. 2). The fan blades 140 are rotatable, e.g., about the longitudinal axis 102. As noted above, the fan 138 is drivingly coupled with the low-pressure turbine 122 via the low-pressure shaft 126. For the embodiments shown in FIG. 2, the fan 138 is coupled with the low-pressure shaft 126 via a speed reduction gearbox 142, e.g., in an indirect-drive or geared-drive configuration.

Moreover, the array of fan blades 140 can be arranged in equal spacing around the longitudinal axis 102. Each fan blade 140 has a root and a tip and a span defined therebetween. Each fan blade 140 defines a central blade axis 144. For this embodiment, each fan blade 140 of the fan 138 is rotatable about its central blade axis 144, e.g., in unison with one another. One or more actuators 146 are provided to facilitate such rotation and therefore may be used to change a pitch of the fan blades 140 about their respective central blades' axes 144.

The fan section 136 further includes a fan guide vane array 148 that includes fan guide vanes 150 (only one shown in FIG. 2) disposed around the longitudinal axis 102. For this embodiment, the fan guide vanes 150 are not rotatable about the longitudinal axis 102. Each fan guide vane 150 has a root and a tip and a span defined therebetween. The fan guide vanes 150 may be unshrouded as shown in FIG. 2 or, alternatively, may be shrouded, e.g., by an annular shroud spaced outward from the tips of the fan guide vanes 150 along the radial direction R or attached to the fan guide vanes 150.

Each fan guide vane 150 defines a central blade axis 152. For this embodiment, each fan guide vane 150 of the fan guide vane array 148 is rotatable about its respective central blade axis 152, e.g., in unison with one another. One or more actuators 154 are provided to facilitate such rotation and therefore may be used to change a pitch of the fan guide vane 150 about its respective central blade axis 152. However, in other embodiments, each fan guide vane 150 may be fixed or unable to be pitched about its central blade axis 152. The fan guide vanes 150 are mounted to a fan cowl 156.

As shown in FIG. 2, in addition to the fan 138, which is unducted, a ducted fan 170 is included aft of the fan 138, such that the engine 100 includes both a ducted and an unducted fan which both serve to generate thrust through the movement of air without passage through at least a portion of the turbomachine 108 (e.g., without passage through the high-pressure compressor 116 and combustion section for the embodiment depicted). The ducted fan 170 is rotatable about the same axis (e.g., the longitudinal axis 102) as the fan blade 140. The ducted fan 170 is, for the embodiment depicted, driven by the low-pressure turbine 122 (e.g., coupled to the low-pressure shaft 126). In the embodiment depicted, as noted above, the fan 138 may be referred to as the primary fan, and the ducted fan 170 may be referred to as a secondary fan. It will be appreciated that these terms “primary” and “secondary” are terms of convenience, and do not imply any particular importance, power, or the like.

The ducted fan 170 includes a plurality of fan blades (not separately labeled in FIG. 2) arranged in a single stage, such that the ducted fan 170 may be referred to as a single stage fan. The fan blades of the ducted fan 170 can be arranged in equal circumferential spacing around the longitudinal axis 102. Each blade of the ducted fan 170 has a root and a tip and a span defined therebetween.

The fan cowl 156 annularly encases at least a portion of the core cowl 110 and is generally positioned outward of at least a portion of the core cowl 110 along the radial direction R. Particularly, a downstream section of the fan cowl 156 extends over a forward portion of the core cowl 110 to define a fan duct flowpath, or simply a fan duct 158. According to this embodiment, the fan flowpath or fan duct 158 may be understood as forming at least a portion of the third stream of the engine 100.

Incoming air may enter through the fan duct 158 through a fan duct inlet 162 and may exit through a fan exhaust nozzle 164 to produce propulsive thrust. The fan duct 158 is an annular duct positioned generally outward of the core duct 130 along the radial direction R. The fan cowl 156 and the core cowl 110 are connected together and supported by a plurality of substantially radially extending and circumferentially spaced stationary struts 160 (only one shown in FIG. 2).

The stationary struts 160 may each be aerodynamically contoured to direct air flowing thereby. Other struts in addition to the stationary struts 160 may be used to connect and support the fan cowl 156 and/or core cowl 110. In many embodiments, the fan duct 158 and the core duct 130 may at least partially co-extend (generally axially) on opposite sides (e.g., opposite radial sides) of the core cowl 110. For example, the fan duct 158 and the core duct 130 may each extend directly from a leading edge 132 of the core cowl 110 and may partially co-extend generally axially on opposite radial sides of the core cowl 110.

The exemplary engine 100 shown in FIG. 2 also defines or includes an inlet duct 166. The inlet duct 166 extends between an engine inlet 168 and the core inlet 112 and fan duct inlet 162. The engine inlet 168 is defined generally at the forward end of the fan cowl 156 and is positioned between the fan 138 and the fan guide vane array 148 along the axial direction A. The inlet duct 166 is an annular duct that is positioned inward of the fan cowl 156 along the radial direction R. Air flowing downstream along the inlet duct 166 is split, not necessarily evenly, into the core duct 130 and the fan duct 158 by a fan duct splitter or the leading edge 132 of the core cowl 110. In the embodiment depicted, the inlet duct 166 is wider than the core duct 130 along the radial direction R. The inlet duct 166 is also wider than the fan duct 158 along the radial direction R.

Notably, for the embodiment depicted, the engine 100 includes one or more features to increase an efficiency of a third-stream thrust, Fn3S (e.g., a thrust generated by an airflow through the fan duct 158 exiting through the fan exhaust nozzle 164, generated at least in part by the ducted fan 170). In particular, the engine 100 further includes an array of inlet guide vanes 172 positioned in the inlet duct 166 upstream of the ducted fan 170 and downstream of the engine inlet 168. The array of inlet guide vanes 172 are arranged around the longitudinal axis 102. For this embodiment, the inlet guide vanes 172 are not rotatable about the longitudinal axis 102.

Each inlet guide vane 172 defines a central blade axis (not labeled for clarity), and is rotatable about its respective central blade axis, e.g., in unison with one another. In such a manner, the inlet guide vanes 172 may be considered a variable geometry component. One or more actuators 174 are provided to facilitate such rotation and therefore may be used to change a pitch of the inlet guide vanes 172 about their respective central blade axes. However, in other embodiments, each inlet guide vanes 172 may be fixed or unable to be pitched about its central blade axis.

Further, located downstream of the ducted fan 170 and upstream of the fan duct inlet 162, the engine 100 includes an array of outlet guide vanes 176. As with the array of inlet guide vanes 172, the array of outlet guide vanes 176 are not rotatable about the longitudinal axis 102. However, for the embodiment depicted, unlike the array of inlet guide vanes 172, the array of outlet guide vanes 176 are configured as fixed-pitch outlet guide vanes.

Further, it will be appreciated that for the embodiment depicted, the fan exhaust nozzle 164 of the fan duct 158 is further configured as a variable geometry exhaust nozzle. In such a manner, the engine 100 includes one or more actuators 178 for modulating the variable geometry exhaust nozzle. For example, the variable geometry exhaust nozzle may be configured to vary a total cross-sectional area (e.g., an area of the nozzle in a plane perpendicular to the longitudinal axis 102) to modulate an amount of thrust generated based on one or more engine operating conditions (e.g., temperature, pressure, mass flowrate, etc. of an airflow through the fan duct 158). A fixed geometry exhaust nozzle may also be adopted.

The combination of the array of inlet guide vanes 172 located upstream of the ducted fan 170, the array of outlet guide vanes 176 located downstream of the ducted fan 170, and the fan exhaust nozzle 164 may result in a more efficient generation of third-stream thrust, Fn3S, during one or more engine operating conditions. Further, by introducing a variability in the geometry of the inlet guide vanes 172 and the fan exhaust nozzle 164, the engine 100 may be capable of generating more efficient third-stream thrust, Fn3S, across a relatively wide array of engine operating conditions, including takeoff and climb (where a maximum total engine thrust FnTotal, is generally needed) as well as cruise (where a lesser amount of total engine thrust, FnTotal, is generally needed).

Moreover, referring still to FIG. 2, in exemplary embodiments, air passing through the fan duct 158 may be relatively cooler (e.g., lower temperature) than one or more fluids utilized in the turbomachine 108. In this way, one or more heat exchangers 180 may be positioned in thermal communication with the fan duct 158. For example, one or more heat exchangers 180 may be disposed within the fan duct 158 and utilized to cool one or more fluids from the core engine 134 with the air passing through the fan duct 158, as a resource for removing heat from a fluid, e.g., compressor bleed air, oil or fuel.

Although not depicted in detail, the heat exchanger 180 may be an annular heat exchanger extending substantially 360 degrees in the fan duct 158 (e.g., at least 300 degrees, such as at least 330 degrees). In such a manner, the heat exchanger 180 may effectively utilize the air passing through the fan duct 158 to cool one or more systems of the engine 100 (e.g., lubrication oil systems, compressor bleed air, electrical components, etc.). The heat exchanger 180 uses the air passing through duct 158 as a heat sink and correspondingly increases the temperature of the air downstream of the heat exchanger 180 and exiting the fan exhaust nozzle 164.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines.

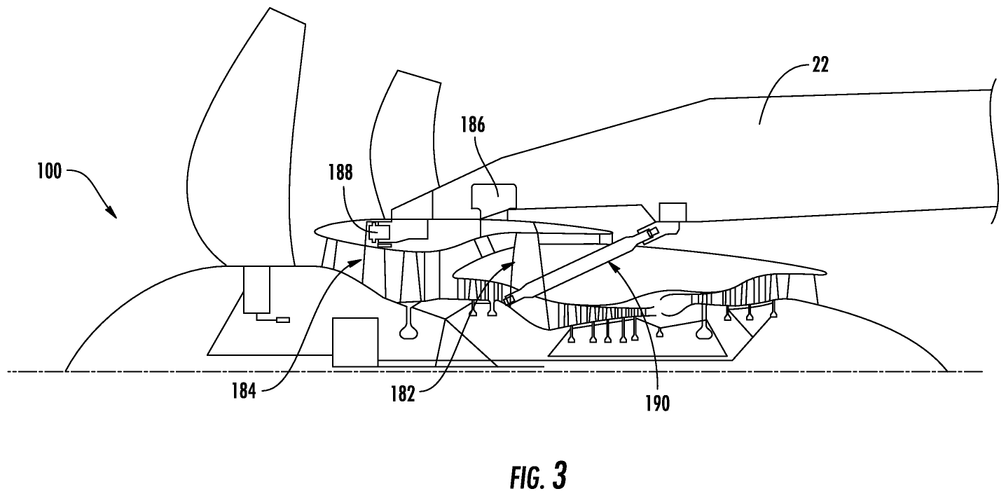

FIG. 3 is a schematic cross-sectional view of the gas turbine engine 100 as shown in FIG. 2 according to exemplary embodiments of the present disclosure. As shown in FIG. 3, the engine 100 further includes an aft frame 182 and a forward frame 184 which is disposed upstream of the aft frame 182 with respect to fluid flow through the engine 100. The aft frame 182 and the forward frame 184 at least partially define the fluid flow path through the gas turbine engine 100. In addition, the aft frame 182 and the forward frame 184 are used to couple or mount the gas turbine engine 100 to the pylon 22 via respective engine mounts 186 and 188. The term “forward frame” as used herein may include any frame that is forward of the aft frame. For example, in particular embodiments, the forward frame may be an inlet frame, a mid-frame or a turbine vane frame.

In certain configurations, the engine 100 may further include a thrust link or linkage 190 that transmits axial, engine thrust loads between the engine 100 and the pylon 22 and/or the airframe of the aircraft 10 shown in FIG. 1.

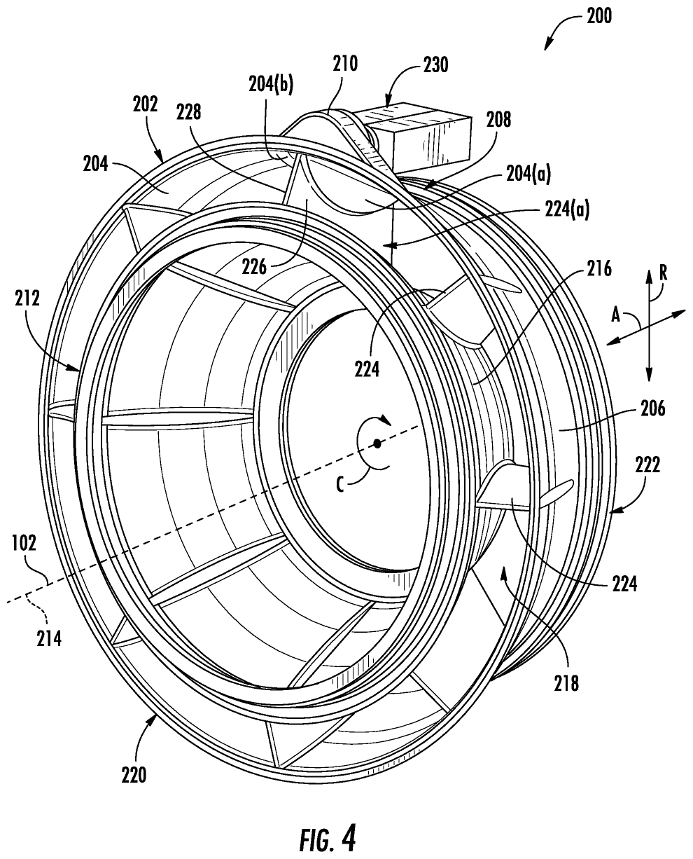

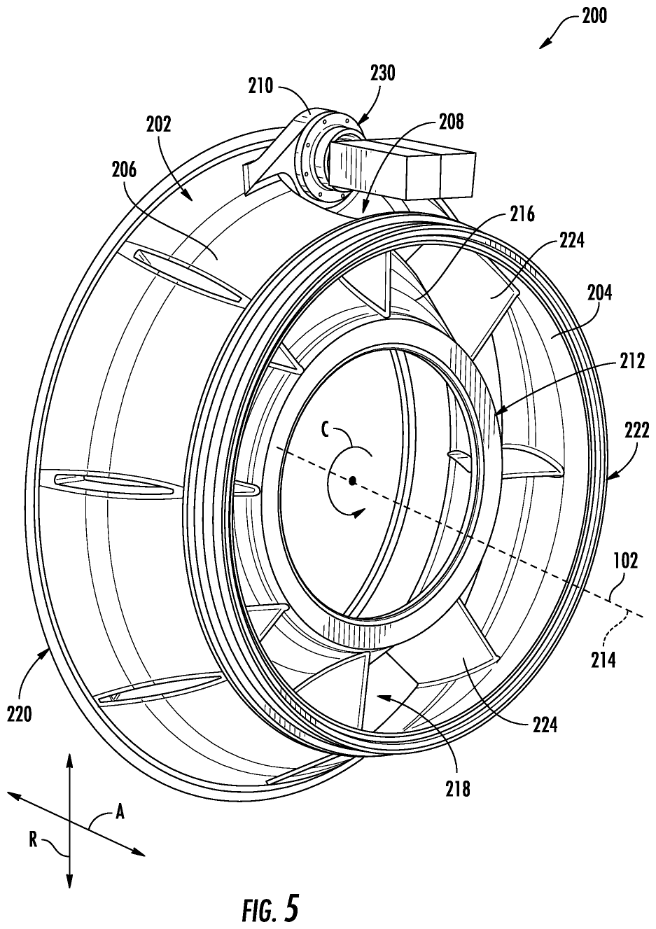

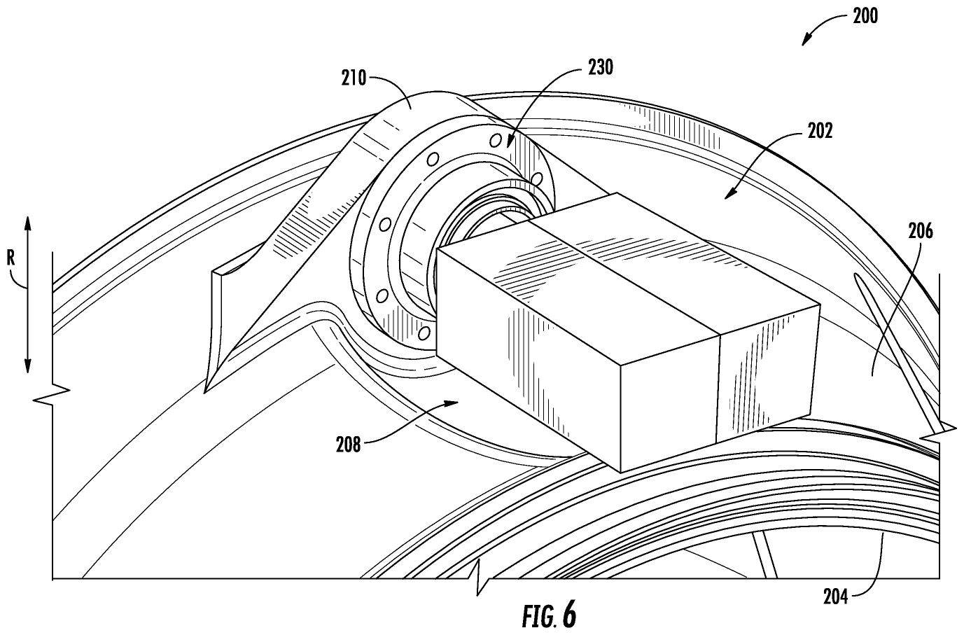

FIG. 4 provides a front perspective view of an exemplary forward frame 200 according to various embodiments of the present disclosure. FIG. 5 provides a back perspective view of the exemplary forward frame 200 as shown in FIG. 4, according to various embodiments of the present disclosure. FIG. 6 is a top partial view of the exemplary forward frame as shown in FIGS. 4 and 5, according to various embodiments of the present disclosure.

In exemplary embodiments, as shown in FIGS. 4, 5 and 6 collectively, the forward frame 200 includes an outer ring 202. The outer ring 202 includes an inner surface 204 that is radially spaced from an outer surface 206 with respect to radial direction R. As shown in FIGS. 5 and 6, the outer ring 202 further includes a first depression or indention 208 defined in the outer surface 206. A first engine mount flange 210 protrudes radially outwardly with respect to radial direction R from the first indention 208.

In exemplary embodiments, as shown in FIGS. 4 and 5, the forward frame 200 includes an inner ring 212 coaxially aligned with the outer ring 202 with respect to axial centerline or longitudinal axis 102 of the gas turbine engine 100 (FIG. 2) and/or axial centerline 214 of the forward frame 200. The inner ring 212 includes an outer surface 216 that is circumferentially surrounded by the outer ring 202. A flow channel 218 is defined between the outer surface 216 of the inner ring 212 and the inner surface 204 of the outer ring 202.

As shown in FIGS. 4 and 5 collectively, the forward frame 200 includes an upstream end 220 axially spaced with respect to axial direction A from a downstream end 222. In various embodiments, the flow channel 218 converges along longitudinal axis 102 or axial centerline 214 between the upstream end 220 and the downstream end 222. In particular embodiments, the forward frame 200 further comprises a plurality of struts. 224 that extend radially from the outer surface 216 of the inner ring 212 to the inner surface 204 of the outer ring 202 within the flow channel 218.

In exemplary embodiments, as shown in FIG. 4, a portion or portions of the inner surface 204 of the outer ring 202 at the first indention 208 as indicated with arrows 204(a) and 204(b) protrudes or extend(s) radially inward with respect to radial direction R and into the flow channel 218. In particular embodiments, as shown in FIG. 4, the inner surface 204 of the outer ring 202 at the first indention 208 extends radially inward into the flow channel 218 at circumferentially opposing sides 226, 228 of a first strut 224(a) of the plurality of struts 224.

In exemplary embodiments, as shown in FIGS. 4, 5 and 6 collectively, the first engine mount flange 210 is configured to mount to the pylon 22 (FIGS. 1 and 3). For example, the first engine mount flange 210 may be connected to a mounting device 230 such as but not limited to a coupler, pin, tab, block or the like which is shaped or formed to interlock with a complementary mounting feature (not shown) of the pylon 22.

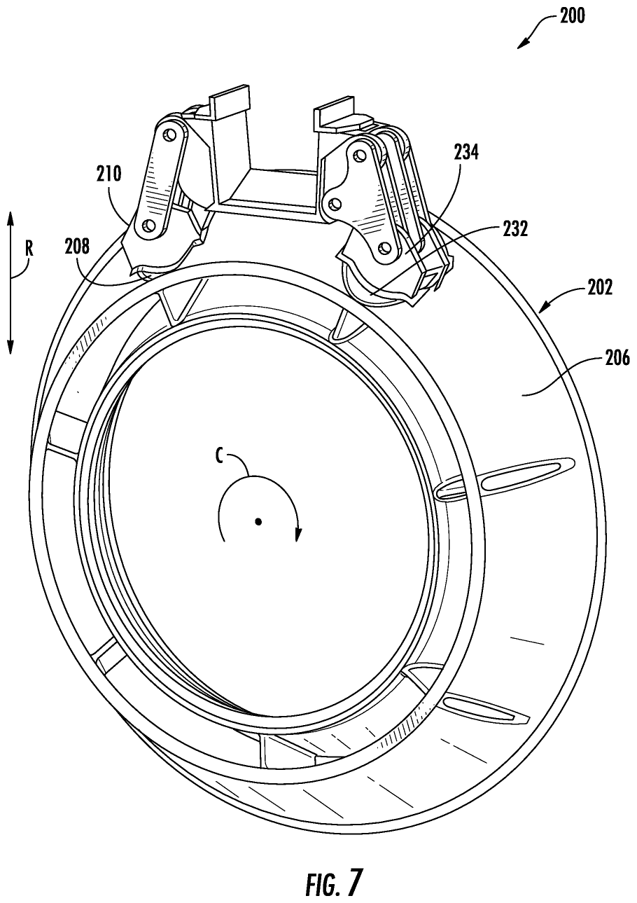

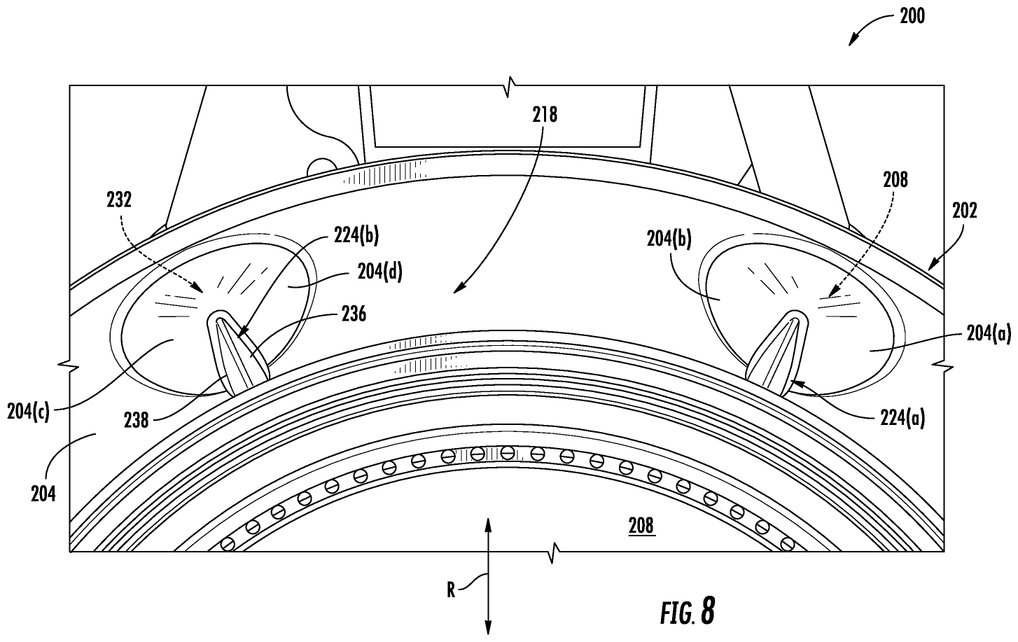

FIG. 7 provides a back or rear side perspective view of the exemplary forward frame 200 according to particular embodiments of the present disclosure. FIG. 8 provides a partial front view of the exemplary forward frame 200 as shown in FIG. 7.

In particular embodiments, as shown in FIGS. 7 and 8 collectively, the outer ring 202 further includes a second indention 232 defined along the outer surface 206 of the outer ring 202 and a second engine mount flange 234 (FIG. 7) protruding radially outwardly from the second indention 232 with respect to radial direction R. The second indention 232 and the second engine mount flange 234 are circumferentially spaced with respect to circumferential direction C from the first indention 208 and the first engine mount flange 210. In particular embodiments, as shown in FIG. 8, the inner surface 204 of the outer ring 202 at the first indention 208 and at the second indention 232 extends radially inward with respect to radial direction R into the flow channel 218.

In particular embodiments, as shown in FIG. 8, a portion or portions of the inner surface 204 of the outer ring 202 at the second indention 232 as indicated with arrows 204(c) and 204(d) protrudes or extend(s) radially inward with respect to radial direction R and into the flow channel 218. In particular embodiments, as shown in FIG. 8, a portion or portions of the inner surface 204 of the outer ring 202 as indicated by 204(c) and 204(d) at the second indention 232 extends radially inward into the flow channel 218 with respect to the radial direction R on circumferentially opposing sides 236, 238 of a second strut 224(b) of the plurality of struts 224 (FIG. 5) with respect to circumferential direction C. The degree of the indention(s) 208, 232 into the forward frame 200, particularly into the flow channel 218 can be parameterized in different ways. For example, the degree or intrusion of the indention into the flow channel 218 may be parameterized as a % of flow blockage through the flow channel 218 at maximum depression bowl size of 0% to 50%. In addition or in the alternative, the degree or intrusion of the indention into the flow channel 218 may be parameterized as a radial extent of blockage, vs. flow-channel span, as viewed cross-sectionally from 0% to 50%.

It is to be appreciated that although it is not illustrated in the figures, the forward frame 200 may include more than two indentions each with respective engine mount flanges depending on the mounting configuration/requirements of a particular engine design. Although not shown, it is also to be appreciated that the gas turbine engine 100 may include two or more forward frames which includes one or more indentions as described above and as shown in FIGS. 4-8. It is also to be appreciated that the number of indentions of each forward frame can be different where multiple forward frames are used.

As previously mentioned, engine mounts are a key constraint on the nacelle flow path and depressing the engine mounts into an engine's frame in the manner described and claimed herein, particularly the forward frame, enables a smoother, lower profile, more continuous curvature flow path around the engine nacelle and any local fairings around the engine mounts. More particularly, the design disclosed herein reduces total drag, peak Mach numbers occurring on the nacelle and/or pylon, and therefore the risk of wave drag.

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine comprising: an aft frame, and a forward frame disposed upstream from the aft frame. The forward frame including an outer ring, wherein the outer ring includes an inner surface radially spaced from an outer surface, a first indention defined in the outer surface, and a first engine mount flange protruding radially outwardly from the first indention.

The gas turbine engine of the preceding clause, wherein the gas turbine engine has an unducted primary fan.

The gas turbine engine of any preceding clause, wherein gas turbine engine is a three-stream gas turbine engine.

The gas turbine engine of any preceding clause, wherein the forward frame further comprises an inner ring including an outer surface circumferentially surrounded by the outer ring, wherein a flow channel is defined between the outer surface of the inner ring and the inner surface of the outer ring.

The gas turbine engine of any preceding clause, wherein the forward frame includes an upstream end axially spaced from a downstream end, wherein the flow channel converges between the upstream end and the downstream end.

The gas turbine engine of any preceding clause, wherein the inner surface of the outer ring at the first indention extends radially inward into the flow channel.

The gas turbine engine of any preceding clause, wherein the forward frame further comprises a plurality of struts that extend radially from the outer surface of the inner ring to the inner surface of the outer ring within the flow channel.

The gas turbine engine of any preceding clause, wherein the inner surface of the outer ring at the first indention extends radially inward into the flow channel at opposing sides of a strut of the plurality of struts.

The gas turbine engine of any preceding clause, wherein the outer ring further includes a second indention defined along the outer surface of the outer ring and a second engine mount flange protruding radially outwardly from the second indention.

The gas turbine engine of any preceding clause, wherein the second indention and the second engine mount are circumferentially spaced from the first indention and the first engine mount flange.

The gas turbine engine of any preceding clause, wherein the forward frame further comprises an inner ring including an outer surface circumferentially surrounded by the outer ring, wherein a flow channel is defined between the outer surface of the inner ring and the inner surface of the outer ring, and wherein the inner surface of the outer ring at the first indention and at the second indention extends radially inward into the flow channel.

The gas turbine engine of any preceding clause, wherein the forward frame further comprises a plurality of struts that extend radially from the outer surface of the inner ring to the inner surface of the outer ring within the flow channel, wherein the inner surface of the outer ring at the first indention extends radially inward into the flow channel at opposing sides of a first strut of the plurality of struts, and the second indention extends radially inward into the flow channel at opposing sides of a second strut of the plurality of struts.

An aircraft, comprising: a wing including a mounting pylon; and a gas turbine engine. The gas turbine engine comprising: a forward frame including an outer ring, wherein the outer ring includes an inner surface that is radially spaced from an outer surface, a first indention defined in the outer surface, and a first engine mount flange protruding radially outwardly from the first indention, wherein the first engine mount flange is coupled to the pylon.

The aircraft of the preceding clause, wherein the gas turbine engine has an unducted primary fan.

The aircraft of any preceding clause, wherein gas turbine engine is a three-stream gas turbine engine.

The aircraft of any preceding clause, wherein the forward frame further comprises an inner ring including an outer surface circumferentially surrounded by the outer ring, wherein a flow channel is defined between the outer surface of the inner ring and the inner surface of the outer ring.

The aircraft of any preceding clause, wherein the forward frame includes an upstream end axially spaced from a downstream end, wherein the flow channel converges between the upstream end and the downstream end.

The aircraft of any preceding clause, wherein the inner surface of the outer ring at the first indention extends radially inward into the flow channel.

The aircraft of any preceding clause, wherein the forward frame further comprises a plurality of struts that extend radially from the outer surface of the inner ring to the inner surface of the outer ring within the flow channel, wherein the inner surface of the outer ring at the first indention extends radially inward into the flow channel at opposing sides of a strut of the plurality of struts.

The aircraft of any preceding clause, wherein the outer ring further includes a second indention defined along the outer surface of the outer ring and a second engine mount flange protruding radially outwardly from the second indention, wherein the second indention and the second engine mount flange are circumferentially spaced from the first indention and the first engine mount flange, wherein the inner surface of the outer ring at the first indention and at the second indention extends radially inward into the flow channel.

We claim:

1. A gas turbine engine comprising:
an aft frame; and
a forward frame disposed upstream from the aft frame, the forward frame including an outer ring, wherein the outer ring includes an inner surface radially spaced from an outer surface, a first indention defined in the outer surface, and a first engine mount flange protruding radially outwardly from the first indention.

2. The gas turbine engine as in claim 1, wherein the gas turbine engine has an unducted primary fan.

3. The gas turbine engine as in claim 1, wherein gas turbine engine is a three-stream gas turbine engine.

4. The gas turbine engine as in claim 1, wherein the forward frame further comprises an inner ring including an outer surface circumferentially surrounded by the outer ring, wherein a flow channel is defined between the outer surface of the inner ring and the inner surface of the outer ring.

5. The gas turbine engine as in claim 4, wherein the forward frame includes an upstream end axially spaced from a downstream end, wherein the flow channel converges between the upstream end and the downstream end.

6. The gas turbine engine as in claim 4, wherein the inner surface of the outer ring at the first indention extends radially inward into the flow channel.

7. The gas turbine engine as in claim 4, wherein the forward frame further comprises a plurality of struts that extend radially from the outer surface of the inner ring to the inner surface of the outer ring within the flow channel.

8. The gas turbine engine as in claim 7, wherein the inner surface of the outer ring at the first indention extends radially inward into the flow channel at opposing sides of a strut of the plurality of struts.

9. The gas turbine engine as in claim 1, wherein the outer ring further includes a second indention defined along the outer surface of the outer ring and a second engine mount flange protruding radially outwardly from the second indention.

10. The gas turbine engine as in claim 9, wherein the second indention and the second engine mount flange are circumferentially spaced from the first indention and the first engine mount flange.

11. The gas turbine engine as in claim 9, wherein the forward frame further comprises an inner ring including an outer surface circumferentially surrounded by the outer ring, wherein a flow channel is defined between the outer surface of the inner ring and the inner surface of the outer ring, and wherein the inner surface of the outer ring at the first indention and at the second indention extends radially inward into the flow channel.

12. The gas turbine engine as in claim 11, wherein the forward frame further comprises a plurality of struts that extend radially from the outer surface of the inner ring to the inner surface of the outer ring within the flow channel, wherein the inner surface of the outer ring at the first indention extends radially inward into the flow channel at opposing sides of a first strut of the plurality of struts, and the second indention extends radially inward into the flow channel at opposing sides of a second strut of the plurality of struts.

13. An aircraft, comprising:
a wing including a mounting pylon; and
a gas turbine engine, the gas turbine engine comprising:
a forward frame including an outer ring, wherein the outer ring includes an inner surface radially spaced from an outer surface, a first indention defined in the outer surface, and a first engine mount flange protruding radially outwardly from the first indention, wherein the first engine mount flange is coupled to the pylon.

14. The aircraft as in claim 13, wherein the gas turbine engine has an unducted primary fan.

15. The aircraft as in claim 13, wherein the gas turbine engine is a three-stream gas turbine engine.

16. The aircraft as in claim 13, wherein the forward frame further comprises an inner ring including an outer surface circumferentially surrounded by the outer ring, wherein a flow channel is defined between the outer surface of the inner ring and the inner surface of the outer ring.

17. The aircraft as in claim 16, wherein the forward frame includes an upstream end axially spaced from a downstream end, wherein the flow channel converges between the upstream end and the downstream end.

18. The aircraft as in claim 16, wherein the inner surface of the outer ring at the first indention extends radially inward into the flow channel.

19. The aircraft as in claim 16, wherein the forward frame further comprises a plurality of struts that extend radially from the outer surface of the inner ring to the inner surface of the outer ring within the flow channel, wherein the inner surface of the outer ring at the first indention extends radially inward into the flow channel at opposing sides of a strut of the plurality of struts.

20. The aircraft as in claim 16, wherein the outer ring further includes a second indention defined along the outer surface of the outer ring and a second engine mount flange protruding radially outwardly from the second indention, wherein the second indention and the second engine mount flange are circumferentially spaced from the first indention and the first engine mount flange, wherein the inner surface of the outer ring at the first indention and at the second indention extends radially inward into the flow channel.
